(19) United States
(12) Patent Application Publication
(10) Pub. No.: US 2018/0256291 A1
(43) Pub. Date: Sep. 13, 2018

(54) Orthodontic Strip

(71) Applicant: OSUNG MND CO., LTD, Gimpo-si, Gyeonggi-do (KR)

(72) Inventor: In-June Choi, Gimpo-si, Gyeonggi-do (KR)

(21) Appl. No.: 15/762,010

(22) PCT Filed: Dec. 18, 2015
(86) PCT No.: PCT/KR2015/013934

§ 371 Date: Mar. 21, 2018

(51) Int. Cl. A61C 3/06; A61C 3/02; A61C 7/02

(52) U.S. Cl. CPC A61C 3/06; A61C 7/02; A61C 3/02

(57) ABSTRACT

Disclosed is an orthodontic strip that includes: a body having a horizontal frame and a pair of vertical frames extending downward at opposite ends of the horizontal frame; a pair of holders coupled to lower ends of the pair of vertical frames, respectively; a grinding blade fixed at opposite ends thereof to the pair of holders; and a handle coupled to a side of any one of the pair of holders, wherein the holders are bent upward while surrounding a lower end of the grinding blade such that the holders surround opposite sides of the grinding blade, and the grinding blade is pressed between the holders.

### TECHNICAL FIELD

The present invention relates generally to an orthodontic strip. More particularly, the present invention relates to an orthodontic strip that comprises a blade for grinding a predetermined portion of a tooth surface to secure space between teeth during a dental procedure, and a body for fixing the blade.

### BACKGROUND ART

In general, during orthodontic treatment in the dental clinic, the tooth surface between the teeth is ground to secure space between the teeth.

In this case, an orthodontic strip is mainly used. A conventional orthodontic strip comprises a blade for grinding teeth, a body for fixing opposite ends of the blade, and a handle connected to both the body and a dental handpiece.

Such a conventional orthodontic strip has a problem in that since the blade is bonded to the body by spot welding, the blade may separate from the body during orthodontic treatment.

Korean Registered Utility Model No. 20-0447443 discloses a grinder for dental clinic in which a grinding member is welded to holders coupled to a body. However, there is a problem in that the grinding member welded to the holders may separate during orthodontic treatment.

### DISCLOSURE

### Technical Problem

Accordingly, the present invention has been made keeping in mind the above problems occurring in the prior art.

First, an object of the present invention is to provide an orthodontic strip that provides a structure whereby a blade for grinding teeth is prevented from separating from a body during orthodontic treatment.

Second, another object of the present invention is to provide an orthodontic strip that provides a reinforcing structure whereby the blade for grinding teeth is prevented from warping.

### Technical Solution

In order to accomplish the above object, an orthodontic strip according to the present invention may include a body having a horizontal frame and a pair of vertical frames extending downward at opposite ends of the horizontal frame.

The orthodontic strip according to the present invention may include a pair of holders coupled to lower ends of the pair of vertical frames, respectively, or integrally formed at the lower ends of the pair of vertical frames, respectively;

The orthodontic strip according to the present invention may include a grinding blade fixed at opposite ends thereof to the pair of holders.

The orthodontic strip according to the present invention may include a handle coupled to a side of any one of the pair of holders or integrally formed on the side of any one of the pair of holders.

In the orthodontic strip according to the present invention, the body may be provided with a reinforcing portion formed along the horizontal frame and the vertical frames.

In the orthodontic strip according to the present invention, the body may be made of a plate having a predetermined thickness, and the reinforcing portion may be formed by embossing along a longitudinal direction of the plate.

In the orthodontic strip according to the present invention, the holders may be bent upward while surrounding a lower end of the grinding blade such that the holders surround opposite sides of the grinding blade, and the grinding blade may be pressed between the holders.

In the orthodontic strip according to the present invention, each of the holders may be provided with a compressing portion having a predetermined depth such that the grinding blade is prevented from separating.

In the orthodontic strip according to the present invention, the grinding blade may be provided with an insertion recess or an insertion hole, into which the compressing portion is inserted.

In the orthodontic strip according to the present invention, the grinding blade may be provided with a plurality of perforations.

In the orthodontic strip according to the present invention, the handle may be formed by rolling the plate extending from the body.

### Advantageous Effects

As described above, an orthodontic strip according to the present invention can be expected to have the following effects.

First, a grinding blade is fixed to the holders coupled to the body, and thus it is possible to prevent the grinding blade from separating from the body during orthodontic treatment.

Second, a reinforcing portion is formed on the body, and thus it is possible to prevent the body from warping during orthodontic treatment.

### DESCRIPTION OF DRAWINGS

FIG. 1 is a perspective view showing an orthodontic strip according to an embodiment of the present invention.

FIG. 2 is an exploded view of FIG. 1.

FIG. 3 is a perspective view showing an embodiment of a grinding blade according to the present invention.

FIGS. 4 to 6 are views showing a process of processing a plate for manufacturing an orthodontic strip according to the embodiment of the present invention.

<Description of the Reference Numerals in the Drawings>

| | | |
|---|---|---|
| 1: plate | 10: body | 12: |

horizontal frame

| | |
|---|---|
| 14: vertical frames | 16: reinforcing portion |

20: holders

| | |
|---|---|
| 22: compressing portion | 30: grinding blade |

32: perforations

| | |
|---|---|
| 34: insertion hole | 40: handle |

### BEST MODE

An orthodontic strip according to a preferred embodiment of the present invention will be described in detail with reference to the accompanying drawings.

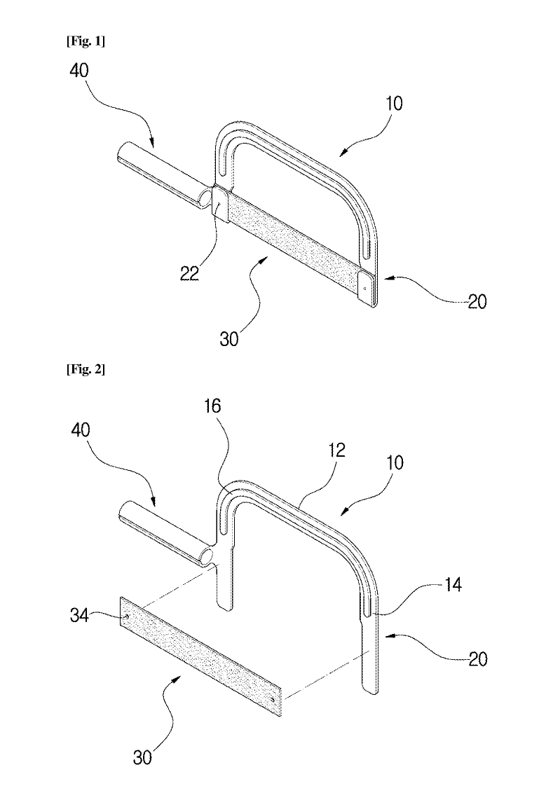

FIGS. 1 to 3 show the orthodontic strip according to an embodiment of the present invention.

The orthodontic strip according to the preferred embodiment of the present invention includes:

a body 10 having a horizontal frame 12 and a pair of vertical frames 14 extending downward from opposite ends of the horizontal frame 12;

a pair of holders 20 coupled to lower ends of the pair of vertical frames 14, respectively;

a grinding blade 30 fixed at opposite ends thereof to the pair of holders 20; and

a handle 40 laterally coupled to any one of the pair of holders 20.

Referring to FIG. 2, the body 10 includes the horizontal frame 12 and the vertical frames 14. The vertical frames 14 extend downward from the opposite ends of the horizontal frame 12, and the horizontal frame 12 and the vertical frames 14 form substantially an inverse U-shape.

In other words, the body 10 is formed to have substantially an inverse U-shape by integrally forming the horizontal frame 12 and the vertical frames 14, and the pair of holders 20 are coupled to the lower ends of the vertical frames 14, respectively.

Further, the body 10 is provided with a reinforcing portion 16 formed along the horizontal frame 12 and the vertical frames 14. The reinforcing portion 16 also has substantially an inverse U-shape.

Further, the horizontal frame 12 and the vertical frames 14 comprising the body 10 may be made of a metal plate 1 having a predetermined thickness, and the reinforcing portion 16 may be formed by embossing along a longitudinal center line of the body 10 to thereby prevent warping of the plate 1. If necessary, the reinforcing portion 16 may be formed in plural.

The holders 20 are provided between the body 10, and serve to fix the grinding blade 30 to the body 10.

The holders 20 may be integrally formed downwardly from the lower ends of the pair of vertical frames 14. When the vertical frames 14 are made of the metal plate 1 having the predetermined thickness, the holders 20 are formed integrally with the plate 1.

The holders 20 are bent upward while surrounding a lower end of the grinding blade 30 such that the holders 20 surround opposite sides of the grinding blade 30, and the grinding blade 30 is pressed between the holders 20.

In other words, the holders 20 are bent in such a manner as to surround opposite side surfaces and a lower end surface of the grinding blade 30, whereby the grinding blade 30 is in contact with the holders 20 on three surfaces except for an upper end surface thereof. Thus, it is possible to three-directionally prevent the grinding blade 30 from separating.

In order to prevent separation of the grinding blade 30, each of the holders 20 may be provided with a compressing portion 22 having a predetermined depth and formed on one side or both sides thereof that press and surround the grinding blade 30. The compressing portion 22 may be formed into various shapes as required, such as points, lines, curves, circles, etc.

The holders 20 may be additionally fixed to the grinding blade 30 by using an adhesive or welding or the like, and the grinding blade 30 is constrained by the holders 20 in three directions. Thus, it is possible to achieve stable fixing of the grinding blade 30.

The grinding blade 30 is a metal sheet having a predetermined thickness. If necessary, diamond powder may be coated on an outer surface of the grinding blade 30.

As shown in FIG. 2, the grinding blade 30 may be provided with a plurality of perforations 32 such that the grinding blade 30 is prevented from being deformed by heat generated by friction with the tooth surface.

The grinding blade 30 may be provided with an insertion recess (not shown) or an insertion hole 34, into which the compressing portion 22 is inserted. In this case, it is possible to further prevent the grinding blade 30 pressed in the holders 20 from positionally deviating.

The grinding blade 30 may be provided at longitudinal opposite ends thereof with a step (not shown), such that the grinding blade 30 is prevented from positionally deviating in a longitudinal direction while being pressed in the holders 20.

The handle 40 serves to connect the body 10 to which the grinding blade 30 is fixed and a dental handpiece with each other, and is coupled to a side of any one of the pair of holders 20.

In addition, the handle 40 may be formed into various shapes to be assembled with a dental handpiece. In the embodiment of the present invention, the handle 40 is formed by rolling the metal plate 1 and has therein a coupling hole through which the handle 40 is assembled with the dental handpiece.

Moreover, the handle 40 is may be integrally formed by extending from the holders 20 in a lateral direction. Specifically, the body 10, the holders 20, and the handle 40 may be integrally formed as a single part.

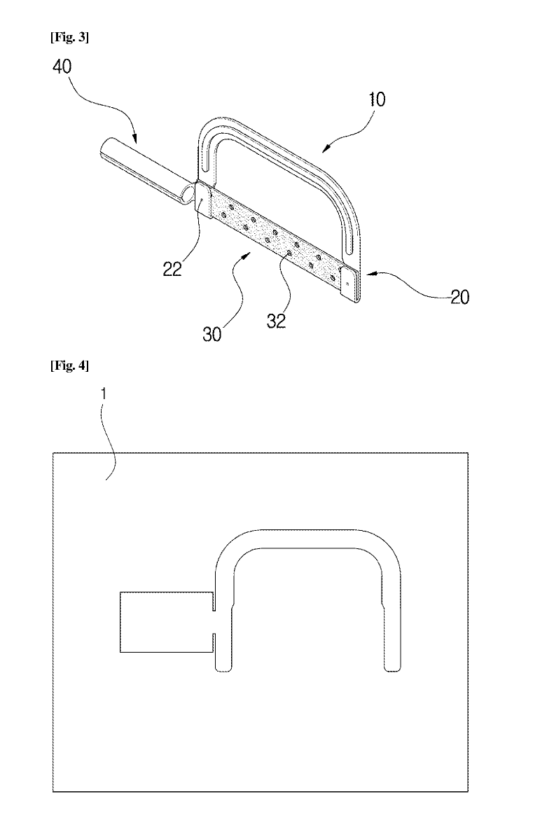

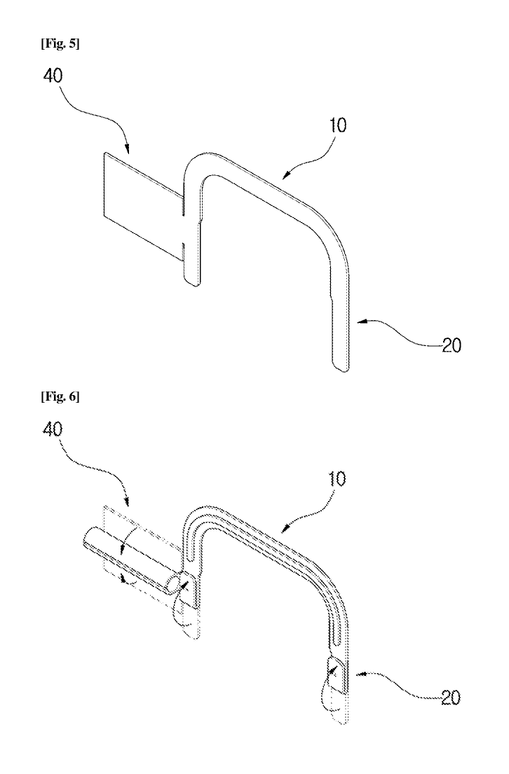

As shown in FIGS. 4 to 6, the body 10, the holders 20, and the handle 40 may be cut from the plate 1 into a single piece formed integrally. Then, the cut-out piece is processed by punching, bending, etc., and then coupled to the grinding blade 30. Thus, it is possible to efficiently produce an orthodontic strip.

The orthodontic strip according to the preferred embodiment of the present invention can be expected to have the following effects.

First, since the grinding blade 30 is fixed to the holders 20 coupled to the body 10, the blade can be prevented from separating from the body 10 during orthodontic treatment. In particular, since the holders 20 surround the grinding blade 30 in three directions, the grinding blade 30 can be fixed more stably.

Further, since the body 10 made of the metal plate 1 having the predetermined thickness is provided with the reinforcing portion 16 formed by embossing along the longitudinal center line of the plate 1, it is possible to prevent the body 10 from warping during orthodontic treatment.

Furthermore, since the grinding blade 30 is provided with the plurality of perforations 32, it is possible to prevent the blade from being deformed by heat generated by friction with the tooth surface.

### INDUSTRIAL APPLICABILITY

The present invention relates to an orthodontic strip, and more particularly, to an orthodontic strip that comprises a blade for grinding a predetermined portion of a tooth surface to secure space between teeth during a dental procedure, and a body for fixing the blade, whereby it is possible to provide a structure in which the blade is prevented from separating from the body.

1. An orthodontic strip, comprising:
a body having a horizontal frame and a pair of vertical frames extending downward at opposite ends of the horizontal frame;
a pair of holders coupled to lower ends of the pair of vertical frames, respectively;
a grinding blade fixed at opposite ends thereof to the pair of holders; and
a handle coupled to a side of any one of the pair of holders,
wherein the holders are bent upward while surrounding a lower end of the grinding blade such that the holders surround opposite sides of the grinding blade, and the grinding blade is pressed between the holders.

2. An orthodontic strip, comprising:
a body having a horizontal frame and a pair of vertical frames extending downward at opposite ends of the horizontal frame;
a pair of holders integrally formed at lower ends of the pair of vertical frames, respectively;
a grinding blade fixed at opposite ends thereof to the pair of holders; and
a handle integrally formed on a side of any one of the pair of holders,
wherein the holders are bent upward while surrounding a lower end of the grinding blade such that the holders surround opposite sides of the grinding blade, and the grinding blade is pressed between the holders.

3. The orthodontic strip of claim 1, wherein the body is provided with a reinforcing portion formed along the horizontal frame and the vertical frames.

4. The orthodontic strip of claim 3, wherein the body is made of a plate having a predetermined thickness, and the reinforcing portion is formed by embossing along a longitudinal direction of the plate.

5. The orthodontic strip of claim 1, wherein each of the holders is provided with a compressing portion having a predetermined depth, such that the grinding blade is prevented from separating.

6. The orthodontic strip of claim 5, wherein the grinding blade is provided with an insertion recess or an insertion hole, into which the compressing portion is inserted.

7. The orthodontic strip of claim 1, wherein the grinding blade is provided with a plurality of perforations.

8. The orthodontic strip of claim 2, wherein the body is provided with a reinforcing portion formed along the horizontal frame and the vertical frames.

9. The orthodontic strip of claim 8, wherein the body is made of a plate having a predetermined thickness, and the reinforcing portion is formed by embossing along a longitudinal direction of the plate.

10. The orthodontic strip of claim 2, wherein each of the holders is provided with a compressing portion having a predetermined depth, such that the grinding blade is prevented from separating.

11. The orthodontic strip of claim 10, wherein the grinding blade is provided with an insertion recess or an insertion hole, into which the compressing portion is inserted.

12. The orthodontic strip of claim 2, wherein the grinding blade is provided with a plurality of perforations.

13. The orthodontic strip of claim 1, wherein the grinding blade is provided with diamond powder coated on thereof.
